(19) United States
(12) Patent Application Publication
(10) Pub. No.: US 2026/0273901 A1
(43) Pub. Date: Sep. 17, 2026

(54) SULFATE MINERAL TRIM AND/OR MOLDING

(71) Applicant: Basix Trim, LLC, Groveland, MA (US)

(72) Inventor: Charles W Mathison, III, Groveland, MA (US)

(21) Appl. No.: 19/080,994

(22) Filed: Mar. 17, 2025

(51) Int. Cl. B32B 19/04; B32B 3/04; B32B 3/08; B32B 3/26; E04F 19/02

(52) U.S. Cl. CPC B32B 19/046; B32B 3/04; B32B 3/08; B32B 3/263; E04F 19/02; B32B 2250/02; B32B 2264/104; B32B 2419/00; B32B 2451/00

(57) ABSTRACT

The system and method for a sulfate mineral trim and/or molding. The sulfate mineral trim and/or molding having an outer layer and an inner core. The inner core may comprise paper. The inner core may comprise calcium sulphate dihydrate, with or without additional additives. The sulfate mineral trim and/or molding having one or more attached adhesive strips for mounting to a surface. The sulfate mineral trim and/or molding being configured to be cut to size and shape without the use of power tools.

### FIELD OF THE DISCLOSURE

The present disclosure relates to trim and/or molding for use in building construction, and more particularly, to trim and/or molding comprising a sulfate mineral.

### BACKGROUND OF THE DISCLOSURE

Conventionally, the application of trims and/or moldings to surfaces such as walls, ceilings, doors, cabinetry, etc. require expertise and power equipment. Historically, decorative details like trim and/or molding are made of wood, stone, plastic and other materials. The installation equipment generally includes air compressors, nail guns, power miter boxes, and the like. Use of these installation techniques requires electricity and generates dust. Once installed, destructive means are required to remove and/or replace conventional trims and/or moldings. Current methods require skilled labor, specialized power equipment, time, and clean up for installation, repair, and restoration.

Wherefore it is an object of the present disclosure to overcome the above-mentioned shortcomings and drawbacks associated with the installation, repair, and removal of trim and/or molding used by the building industry.

### SUMMARY OF THE DISCLOSURE

It has been recognized that the building industry utilizes numerous power tools, comprising specialized equipment, that require electricity and skilled labor for the installation, repair, and removal of trim and/or molding. These conventional methods generate harmful dust and other debris during installation, repair, and removal of trim and/or molding and thus require additional manpower for clean-up.

One aspect of the present disclosure is a system comprising a reversibly removable, sulfate mineral trim and/or molding. In some cases, the reversibly removable, sulfate mineral trim and/or molding can be installed using only hand tools.

In some aspects, the techniques described herein relate to a removable trim and/or molding comprising a sulfate mineral, the removable trim and/or molding having a length, a width, and at least one thickness when viewed in cross-section.

In some aspects, the techniques described herein relate to a removable trim and/or molding, further comprising an inner core and an outer layer. n some aspects, the techniques described herein relate to a removable trim and/or molding, wherein the outer layer includes paper.

In some aspects, the techniques described herein relate to a removable trim and/or molding, wherein the inner core includes calcium sulphate dihydrate. In some aspects, the techniques described herein relate to a removable trim and/or molding, wherein the inner core further includes additives.

In some aspects, the techniques described herein relate to a removable trim and/or molding, further comprising at least one adhesive strip attached to a surface of the removable trim and/or molding to use in attaching the removable trim and/or molding to a surface.

Another aspect of the present disclosure is a system comprising a removable trim and/or molding comprising: an inner core comprising a sulfate mineral; and an outer layer comprising paper, wherein the removable trim and/or molding has a length, a width, and at least one thickness when viewed in cross-section.

In some aspects, the techniques described herein relate to a trim and/or molding, wherein the inner core includes calcium sulphate dihydrate. In some aspects, the techniques described herein relate to a trim and/or molding, wherein the inner core further includes additives.

In some aspects, the techniques described herein relate to a trim and/or molding, further comprising at least one adhesive strip attached to a surface of the trim and/or molding to use in attaching the trim and/or molding to a surface.

Yet another aspect of the present disclosure is a method of using a trim and/or molding, comprising scoring an outer layer with a utility knife to form a surface score; bending the trim and/or molding along the surface score; and breaking an inner core to separate a discard portion from a remaining portion of the trim and/or molding.

In some aspects, the techniques described herein relate to a method, further comprising: peeling a backing off of at least one adhesive strip attached to the remaining portion of the trim and/or molding; and pressing the remaining portion of the trim and/or molding against a surface to install the trim and/or molding on the surface.

In some aspects, the techniques described herein relate to a method, further comprising: removing the trim and/or molding from the surface using only hand tools.

In some aspects, the techniques described herein relate to a method, wherein the outer layer includes paper and the inner core includes calcium sulphate dihydrate.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a perspective view of a portion of one implementation of a sulfate mineral trim and/or molding according to the principles of the present disclosure.

FIG. 2 shows a rear view of a portion of one implementation of a sulfate mineral trim and/or molding according to the principles of the present disclosure.

FIG. 3 shows a cross-sectional view of one implementation of a sulfate mineral trim and/or molding according to the principles of the present disclosure.

FIG. 4 shows a cross-sectional view of another implementation of a sulfate mineral trim and/or molding according to the principles of the present disclosure.

FIG. 5 is a flowchart of a method of or using one implementation of a sulfate mineral trim and/or molding according to the principles of the present disclosure.

### DETAILED DESCRIPTION OF THE DISCLOSURE

Currently, the building industry utilizes numerous power tools, comprising specialized equipment, that require electricity and skilled labor, for the installation, repair, and removal of trim and/or molding. These conventional methods generate harmful dust and other debris during installation, repair, and removal of trim and/or molding and thus require additional manpower for clean-up.

In contrast, one implementation of the sulfate mineral trim and/or molding of the present disclosure, can be installed using only hand tools. In some cases, a knife, a pencil, a square, and a tape measure are all that is needed to trim a window or door, install a baseboard or a crown molding, or the like.

Certain implementations of the sulfate mineral trim and/or molding of the present disclosure help to reduce energy use and waste. In some cases, the material is calcium sulphate dihydrate, or gypsum. This material is widely available and is chemically inert. It has many uses comprising plaster, wallboard, Portland cement and as a soil conditioner.

In contrast, the installation and removal of trim and/or molding made of conventional materials require the use of eye and respiratory protection, in addition to hearing protection. Additionally, the installation and removal of trim and/or molding made of conventional materials may require specific disposal protocols due to the use of toxic and/or man-made materials.

There is a need for producing a trim and/or molding material that is environmentally acceptable—not toxic—and useful in construction. The Occupational Safety and Health Administration (OSHA) has set the legal limit (permissible exposure limit) for gypsum exposure in the workplace as a time-weighted average (TWA) of 15 mg/m³ for total exposure and TWA 5 mg/m³ for respiratory exposure over an eight-hour workday. The National Institute for Occupational Safety and Health (NIOSH) has set a recommended exposure limit (REL) of TWA 10 mg/m³ for total exposure and TWA 5 mg/m³ for respiratory exposure over an eight-hour workday.

In some cases, the sulfate mineral trim and/or molding of the present disclosure may be manufactured using extrusion techniques. In some implementations, the composition of the extruded sulfate mineral material may contain calcium sulfate dihydrate with or without additives. Additives may be used to provide various characteristics in the finished products. Alternatively, additives may be used to facilitate manufacture. Some desirable characteristics of the trim and/or molding made from a sulfate mineral composition include being non-toxic, fire-retardant, fire-resistant, water-repellent, crack-resistant, and the like.

In some implementations of the sulfate mineral trim and/or molding of the present disclosure, a slurry containing the sulfate mineral material is extruded and then rolled out to a desired thickness and dried. In some cases, depending on the composition of the sulfate mineral material slurry, it may be cured after it has been extruded and formed into a desired shape. In some cases, a particular thickness and/or a particular cross-sectional profile is chosen for the trim and/or molding depending on the final application. In still other implementations, a slurry may be rolled using rollers having a cross section that will produce a variety of cross-sectional profiles in the finished product.

In some cases, the sulfate mineral material trim and/or molding is held at a constant temperature during extrusion and/or forming. In some cases, the sulfate mineral material is extruded into molds that have various cross-sectional profiles to suit the various trims and/or moldings used in construction, and the like. Some non-limiting cross-sectional profiles include those used for window and door casings, baseboards, crown molding, chair rails, aprons, trim, and the like.

In certain implementations of the present disclosure, the sulfate mineral trim and/or molding is reversibly attachable to a surface such as a wall or a ceiling. In some cases, the reversible attachment of the trim and/or molding is via the use of one or more strips of double-sided adhesive. In some cases, the trim and/or molding have pre-installed adhesive strips to facilitate installation.

Adhesives are substances that bind materials together through surface attachment. They operate on principles of adhesion (bonding to a surface) and cohesion (internal strength within the adhesive). Adhesives can be derived from natural sources or synthetically produced, offering a wide range of properties and uses. Adhesives may be water or solvent based and may have additives such as carbon nanotubes or fibers that help improve binding and strength. In some implementations of the present disclosure, pressure-sensitive adhesives (PSAs) are used. PSAs are composed of three main components: a viscous adhesive polymer, a tackifier, and a backing material. The adhesive polymer provides the bonding properties, while the tackifier enhances its stickiness. And the backing material provides support and stability. Together, these components create a versatile adhesive that can bond to a wide range of surfaces. PSAs can even adhere to uneven or irregular surfaces.

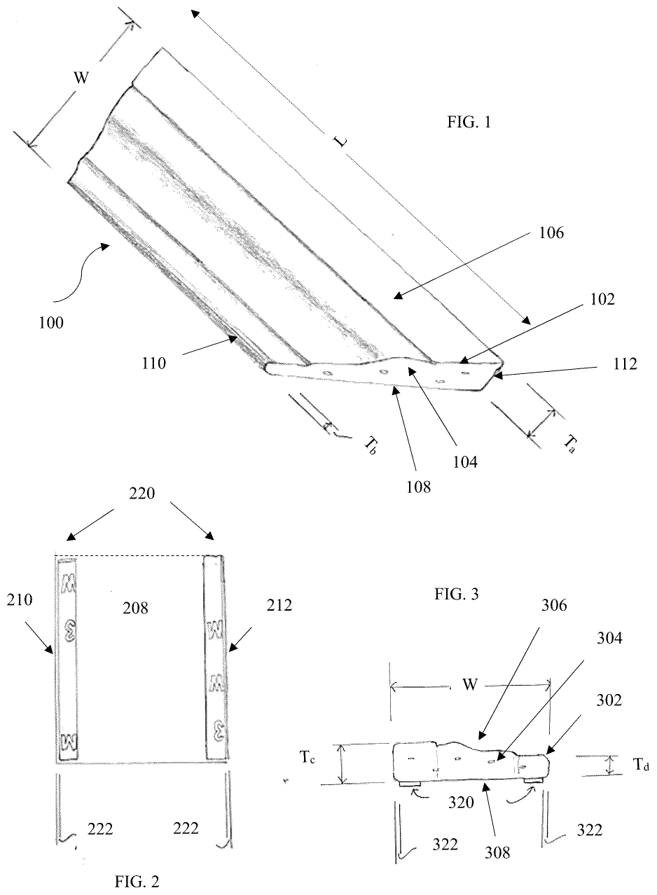

Referring FIG. 1, a perspective view of a portion of one implementation of a sulfate mineral trim and/or molding according to the principles of the present disclosure is shown. More specifically, a portion of one implementation of sulfate mineral trim and/or molding has an inward surface 108 (not shown) which when installed would not be in view, an outward facing surface 106, one or more outer edges 110, 112. In one implementation of a sulfate mineral trim and/or molding an outer layer 102 surrounds an inner core 104. In some cases, the inner core 104 comprises calcium sulphate dihydrate. In some cases, the outer layer 102 comprises paper.

In certain implementations of a sulfate mineral trim and/or molding the outward facing surface 106 is decorative and/or functional. In some implementations, the inward surface 108 planar to facilitate contact with a surface during installation. Implementations of the sulphate mineral trim and/or molding have a length (L), a width (W), and one or more thicknesses depending on the cross-sectional profile of the trim and/or molding (Tₐ, T_{b}.)

In certain implementations of the present disclosure, the length (L) of a sulfate mineral trim and/or molding is about 1 foot, about 2 feet, about 3 feet, about 4 feet, about 5 feet, about 6 feet, about 7 feet, about 8 feet, about 9 feet, about 10 feet, about 11 feet, or about 12 feet.

In certain implementations of the present disclosure, the width (W) of a sulfate mineral trim and/or molding is about 1 inch, about 2 inches, about 3 inches, about 4 inches, about 5 inches, about 6 inches, about 7 inches, about 8 inches, about 9 inches, about 10 inches, about 11 inches, or about 12 inches.

In certain implementations of the present disclosure, the at least one thickness (T) of a sulfate mineral trim and/or molding is about ¼ inch, about ½ inch, about ¾ inch, about 1 inch, about 1¼ inch, about 1½ inch, about 1¾ inch, or about 2 inches. In certain implementations of the present disclosure, the at least one thickness (T) of a sulfate mineral trim and/or molding is about 2¼ inch, about 2½ inch, about 2¾ inch, about 3 inches, about 3¼ inch, about 3½ inch, about 3¾ inch, or about 4 inches. In certain implementations of the present disclosure, the at least one thickness (T) of a sulfate mineral trim and/or molding is about 4¼ inch, about 4½ inch, about 4¾ inch, about 5 inches, about 5¼ inch, about 5½ inch, about 5¾ inch, or about 6 inches. In certain implementations of the present disclosure, the at least one thickness (T) of a sulfate mineral trim and/or molding is about 6¼ inch, about 6½ inch, about 6¾ inch, about 7 inches, about 7¼ inch, about 7½ inch, about 7¾ inch, or about 8 inches.

Referring to FIG. 2, a rear view of a portion of one implementation of a sulfate mineral trim and/or molding according to the principles of the present disclosure is shown. More specifically, in certain implementations of the sulfate mineral trim and/or molding one or more adhesive strips 220 are attached to the inward surface 208. In certain implementations, one or more adhesive strips 220 are applied distance away 222 from an outer edge 210, 212.

Referring to FIG. 3, a cross-sectional view of one implementation of a sulfate mineral trim and/or molding according to the principles of the present disclosure is shown. More specifically, one implementation of a molding and/or trim in cross-section has an outward facing surface 306 and an inward surface 308. In some cases, an outward facing surface 306 has a profile producing a decorative effect, which creates several different thicknesses moving across the profile. Here, T_{c} and T_{d} are shown as just two of the thicknesses (T_{c} on a first outer edge and T_{d} on a second outer edge). As seen in the figure, it is clear that throughout the width of the cross-sectional profile the thicknesses of the trim and/or molding changes. In some implementations of the trim and/or molding one or more adhesive strips 320 are placed on an inner surface, which may be the surface used to attach the trim and/or molding to a wall, a ceiling, or the like. In some cases, the one or more adhesive strips 320 are applied to the trim and/or molding a distance 322 away from an outer edge so when the installed trim and/or molding is viewed, the one or more adhesive strips 320 are not visible. Some implementations of the trim and/or molding of the present disclosure have an inner core 304 and an outer layer 302. In some cases, the outer layer 302 facilitates the formation and/or retention of a finished shape of a trim and/or molding. In other cases, the outer layer 302 reduces the amount of dust produced when the trim and/or molding is cut to length and/or cut at a desired angle for a particular application. See, for example, FIG. 1, where an exposed edge has been cut at a 45° angle. It is to be understood that the lengths of a molding and/or trim can be cut to length to suit a particular application and may also be cut at a desired angle to frame a door or window, or to meet at an inside or outside corner in the case of a crown molding, a base board, a chair rail, or the like.

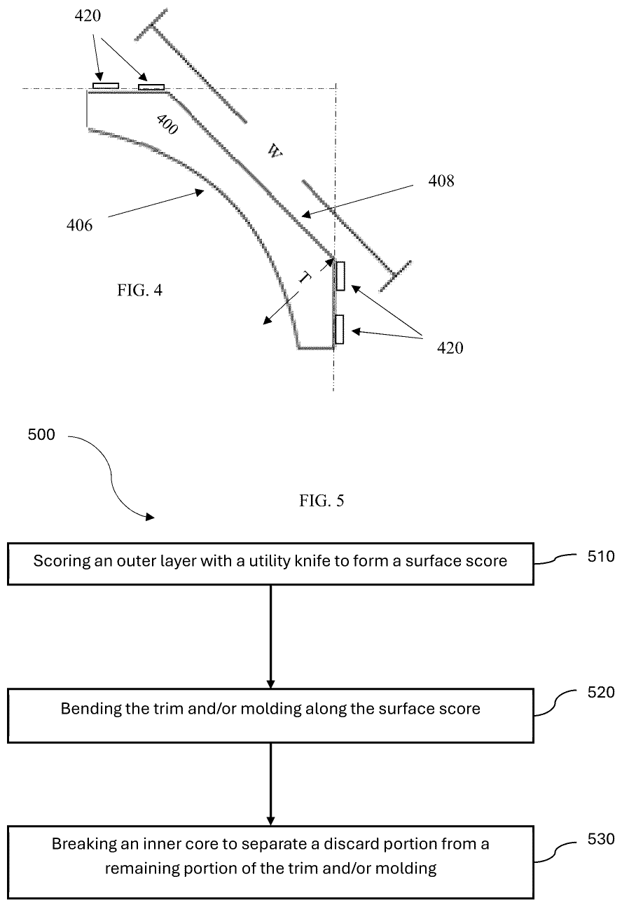

Referring to FIG. 4, a cross-sectional view of another implementation of a sulfate mineral trim and/or molding according to the principles of the present disclosure is shown. More specifically, in certain implementations of a sulfate mineral trim and/or molding an outer facing surface 406 is opposite an inward surface 408, but rather than attaching the trim and/or molding via adhesive strips applied on an inward surface, the attachment is at one or more out edges. In this implementation, the trim and/or molding has a profile of a crown molding, and the attachment points are shown having one or more adhesive strips 420. This method of application creates an open space behind the molding formed when the molding 400 is applied at a corner formed where a ceiling and a wall meet. It is to be understood that the application surfaces of a trim and/or molding may be at whatever surface is desired for particular application and that the use of outward facing surface, inward surface, and one or more outer edges is used only to facilitate the description of the figures but are non-limiting.

Referring to FIG. 5, a flowchart of a method of using one implementation of a sulfate mineral trim and/or molding 500 according to the principles of the present disclosure is shown. More specifically, at step 510, an outer layer is scored with a utility knife to form a surface score. At step 520, the trim and/or molding are bent along the surface score. At step 530, an inner core is broken to separate a discard portion from a remaining portion of the trim and/or molding. In certain implementations, the method further comprises peeling a backing off of at least one adhesive strip attached to the remaining portion of the trim and/or molding; and pressing the remaining portion of the trim and/or molding against a surface to install the removable trim and/or molding on the surface.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally comprising elements other than B); in another implementation, to B only (optionally comprising elements other than A); in yet another implementation, to both A and B (optionally comprising other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also comprising more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily comprising at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally comprising more than one, A, with no B present (and optionally comprising elements other than B); in another implementation, to at least one, optionally comprising more than one, B, with no A present (and optionally comprising elements other than A); in yet another implementation, to at least one, optionally comprising more than one, A, and at least one, optionally comprising more than one, B (and optionally comprising other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the disclosure. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

As used herein in the specification and claims, comprising as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “comprising,” “carrying,” “having,” “containing,” “involving,” “holding,” “composed of,” and the like are to be understood to be open-ended, i.e., to mean comprising but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

While the principles of the disclosure have been described herein, it is to be understood by those skilled in the art that this description is made only by way of example and not as a limitation as to the scope of the disclosure. Other implementations are contemplated within the scope of the present disclosure in addition to the exemplary implementations shown and described herein. Modifications and substitutions by one of ordinary skill in the art are considered to be within the scope of the present disclosure.

What is claimed:

1. A trim and/or molding comprising a sulfate mineral, the trim and/or molding having a length, a width, and at least one thickness when viewed in cross-section.

2. The trim and/or molding according to claim 1, further comprising an inner core and an outer layer.

3. The trim and/or molding according to claim 2, wherein the outer layer comprises paper.

4. The trim and/or molding according to claim 2, wherein the inner core comprises calcium sulphate dihydrate.

5. The trim and/or molding according to claim 4, wherein the inner core further comprises additives.

6. The trim and/or molding according to claim 1, further comprising at least one adhesive strip attached to a surface of the trim and/or molding to use in attaching the trim and/or molding to a surface.

7. A trim and/or molding comprising:
an inner core comprising a sulfate mineral; and
an outer layer comprising paper,
wherein the trim and/or molding has a length, a width, and at least one thickness when viewed in cross-section.

8. The trim and/or molding according to claim 7, wherein the inner core comprises calcium sulphate dihydrate.

9. The trim and/or molding according to claim 8, wherein the inner core further comprises additives.

10. The trim and/or molding according to claim 7, further comprising at least one adhesive strip attached to a surface of the trim and/or molding to use in attaching the trim and/or molding to a surface.

11. A method of using a trim and/or molding, comprising:
scoring an outer layer with a utility knife to form a surface score;
bending the trim and/or molding along the surface score; and
breaking an inner core to separate a discard portion from a remaining portion of the trim and/or molding.

12. The method of using a trim and/or molding according to claim 11, further comprising:
peeling a backing off of at least one adhesive strip attached to the remaining portion of the trim and/or molding; and
pressing the remaining portion of the trim and/or molding against a surface to install the trim and/or molding on the surface.

13. The method of using a trim and/or molding according to claim 12, further comprising:
removing the trim and/or molding from the surface using only hand tools.

14. The method of using a trim and/or molding according to claim 11, wherein the outer layer comprises paper and the inner core comprises calcium sulphate dihydrate.
